(19) United States
(12) Patent Application Publication
(10) Pub. No.: US 2023/0062430 A1
(43) Pub. Date: Mar. 2, 2023

(54) METHOD OF GENERATING DEVICE STRUCTURE PREDICTION MODEL AND DEVICE STRUCTURE SIMULATION APPARATUS

(71) Applicant: Samsung Electronics Co., Ltd., Suwon-si (KR)

(72) Inventors: Ami MA, Suwon-si (KR); Hyeonkyun NOH, Gwangmyeong-si (KR); Shinwook YI, Suwon-si (KR); Dongchul IHM, Suwon-si (KR); Kyubaik CHANG, Seoul (KR); Jaehoon JEONG, Hwaseong-si (KR)

(73) Assignee: Samsung Electronics Co., Ltd., Suwon-si (KR)

(21) Appl. No.: 17/890,557

(22) Filed: Aug. 18, 2022

(30) Foreign Application Priority Data
Aug. 25, 2021 (KR) 10-2021-0112656

(51) Int. Cl. G06N 20/00

(52) U.S. Cl. CPC G06N 20/00

(57) ABSTRACT

A device structure simulation apparatus includes a memory storing a device structure simulation program and a processor configured to execute the device structure simulation program stored in the memory. By executing the device structure simulation program, the device structure simulation apparatus is further configured to receive spectrum data of a target device, generate an input data set by performing preprocessing on the spectrum data, and train a model based on the input data set such that the model is configured to predict a structure of the target device. The preprocessing including selecting a certain basis function based on the spectrum data and separating the spectrum data into sets of certain basis functions, and the model includes at least one sub model.

### CROSS-REFERENCE TO RELATED APPLICATION

This application is based on and claims priority under 35 U.S.C. § 119 to Korean Patent Application No. 10-2021-0112656, filed on Aug. 25, 2021, in the Korean Intellectual Property Office, the disclosure of which is incorporated by reference herein in its entirety.

### BACKGROUND

The inventive concepts relate to a method of generating a device structure prediction model and a device structure simulation apparatus, and more particularly, to a method of generating a prediction model, which predicts a device structure, using a stacking model (and/or a meta-learning model) and a device structure simulation apparatus including the prediction model.

A neural network refers to a computational architecture that models a biological brain. As neural network technology has recently been developed, there has been a lot of research into analyzing input data and extracting valid information using a neural network device, which uses at least one neural network model, in various kinds of electronic systems.

To increase the performance of simulators of semiconductor processes and/or semiconductor measuring equipment, much time and cost has been spent on sample preparation and reference data measurement, and engineers have personally adjusted parameters using physical knowledge. Recently, there has been a lot of research into using neural network technology, but overfitting by minor training data is still occurring.

### SUMMARY

The inventive concepts provide an apparatus for deriving a robust prediction result by using a model generated using a stacking method and for overcoming vulnerability caused by deficient data by using a meta-learning model, in a process of measuring a semiconductor device structure.

According to an aspect of the inventive concepts, there is provided a device structure simulation apparatus including a memory storing a device structure simulation program and a processor configured to execute the device structure simulation program stored in the memory. By executing the device structure simulation program, the device structure simulation apparatus is further configured to receive spectrum data of a target device, generate an input data set by performing preprocessing on the spectrum data, and train a model based on the input data set such that the model is configured to predict a structure of the target device. The preprocessing including selecting a certain basis function based on the spectrum data and separating the spectrum data into sets of certain basis functions; and the model includes at least one sub model.

According to another aspect of the inventive concepts, there is provided a method of creating a model predicting a structure of a target device. The method includes receiving spectrum data of the target device, generating an input data set by performing preprocessing on the spectrum data, and training the model based on the input data set such that the model is configured to predict the structure of the target device. The input data set includes simulation data and measurement data. The model includes at least a first sub model and a second sub model, the first sub model trained based on the simulation data, and the second sub model trained based on the measurement data.

According to a further aspect of the inventive concepts, there is provided a method of creating a model predicting a structure of a target device. The method includes receiving spectrum data of the target device, generating an input data set by performing preprocessing on the spectrum data, pre-training the model based on previous data, and retraining the pre-trained model based on the input data set such that the retrained model is configured to predict the structure of the target device.

### BRIEF DESCRIPTION OF THE DRAWINGS

Example embodiments of the inventive concepts will be more clearly understood from the following detailed description taken in conjunction with the accompanying drawings in which:

FIGS. 1A and 1B illustrate device structure simulation systems according to some example embodiments;

FIGS. 2A and 2B are diagrams for describing a method of measuring a device structure, according to a comparative example;

FIG. 3 is a diagram of a device structure simulation system according to some example embodiments;

FIG. 4 is a flowchart of a method of simulating a device structure, according to some example embodiments;

FIG. 5 is a flowchart of a method of simulating a device structure, according to some example embodiments;

FIG. 6 is a diagram of a device structure simulation system according to some example embodiments;

FIG. 7A is a flowchart of a method of simulating a device structure, according to some example embodiments; FIG. 7B is a flowchart of a comparative example;

FIG. 8A is a flowchart of a method of simulating a device structure, according to some example embodiments; FIG. 8B is a flowchart of a meta-learning algorithm according to some example embodiments;

FIGS. 9A to 9C are diagrams for describing preprocessing according to some example embodiments;

FIG. 10 is a block diagram illustrating an apparatus including an integrated circuit according to some example embodiment; and

FIG. 11 is a block diagram of a device structure simulation system including a neural network device, according to some example embodiments.

### DETAILED DESCRIPTION OF THE EMBODIMENTS

Hereinafter, example embodiments are described in detail with reference to the accompanying drawings.

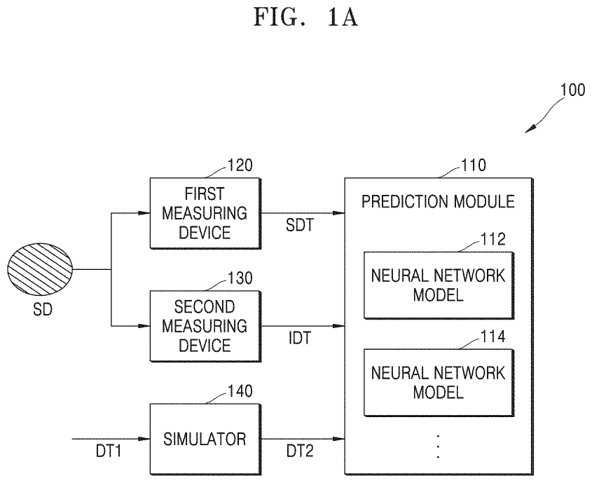

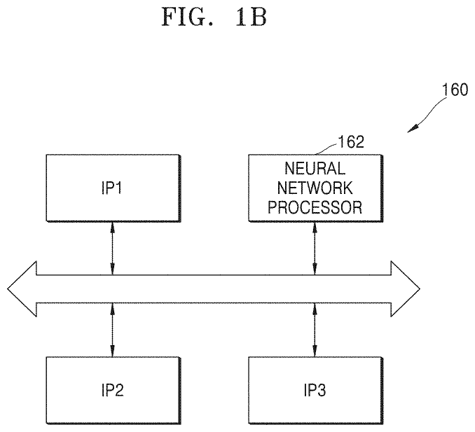

FIG. 1A illustrates a device structure simulation system 100 according to some example embodiments.

The device structure simulation system 100 may include a prediction module 110, a first measuring device 120, a second measuring device 130, and a simulator 140. The device structure simulation system 100 may further include other universal elements such as memory, a communication module, a video module (e.g., a camera interface, a Joint Photographic Experts Group (JPEG) processor, a video processor, or a mixer), a three-dimensional (3D) graphics core, an audio system, a display driver, a graphics processing unit (GPU), a digital signal processor (DSP), and/or the like.

The prediction module 110 may analyze input data based on a neural network, extract valid information from the input data, and predict a device structure based on the valid information or control the configuration of a simulation apparatus, on which the prediction module 110 is mounted. For example, the prediction module 110 may be applied to (and/or included in) a simulator, a mobile device, an image display device, measuring equipment, an Internet of things (IoT) device, and/or the like, which models and/or monitors an object in a computing system, and mounted on any other various kinds of electronic devices.

The prediction module 110 may generate a neural network (e.g., train and/or learn a neural network), perform an operation of a neural network (e.g., based on received input data), generate an information signal based on an operation result, and/or retrain a neural network. The prediction module 110 may include a hardware accelerator to execute a neural network. For example, the hardware accelerator may include a dedicated processing circuitry, such as a neural processing unit (NPU), a tensor processing unit (TPU), a neural engine, and/or the like, for execution of a neural network, but is not limited thereto.

The prediction module 110 may execute a plurality of neural network models 112 and 114. The neural network model 112 may refer to, e.g., a deep learning model, which is trained to perform a specific operation such as device structure prediction, process simulation, and/or image classification. The prediction module 110 may correspond to a neural network model that is used to extract an information signal the device structure simulation system 100 desires. For example, the neural network model 112 may include at least one of various kinds of neural network models such as a convolution neural network (CNN), a region with CNN (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, a Bayesian Neural Network (BNN) and/or the like. Additionally (and/or alternatively), the deep learning model(s) may be trained based on at least one of various algorithms such as regression, linear and/or logistic regression, random forest, a support vector machine (SVM), and/or other types of models, such as statistical clustering, Bayesian classification, decision trees, dimensionality reduction such as principal component analysis, expert systems, and/or combinations thereof including ensembles such as random forests.

The prediction module 110 may use various algorithms, such as a meta-learning algorithm and/or an ensemble algorithm including voting, bagging, boosting, and/or stacking, to train neural network models, but the example embodiments are not limited thereto.

The neural network model 112 may be generated by a learning device (e.g., processing circuitry and/or a server training a neural network based on a large amount of input data) through training and executed by the prediction module 110. Hereinafter, the neural network model 112 refers to a neural network of which the configuration parameters (e.g., a network topology, a bias, and a weight) are determined through training. The configuration parameters of the neural network model 112 may be updated through retraining by the learning device, and the neural network model 112 with updated configuration parameters may be applied to the prediction module 110.

The prediction module 110 may receive spectrum signal data SDT generated, e.g., by the first measuring device 120 and may perform preprocessing on the spectrum signal data SDT. The preprocessing may include various kinds of transforms including wavelet transforms and/or various kinds of decomposition including cross decomposition.

The first measuring device 120 may measure a device structure. For example, the first measuring device 120 may include an ellipsometer. The first measuring device 120 may detect changes in polarization properties of light using various methods and measure a complex refractive index of a material. For example, the first measuring device 120 may measure a polarization state change in light after the light is reflected (and/or transmitted from the device) and, based on measured data, measure a basic physical quantity (e.g., a complex refractive index or a dielectric function tensor) of a material and/or deduce the form (e.g., crystalline state, chemical structure, electrical conductivity, and/or the like) of the material. The first measuring device 120 may generate the spectrum signal data SDT based on a target semiconductor device SD.

The second measuring device 130 may also measure a device structure. The second measuring device 130 may include an electron microscope (e.g., a scanning electron microscope (SEM) and/or a transmission electron microscope (TEM)). The second measuring device 130 may measure a reference sample (e.g., from a target semiconductor device SD) and generate structure data IDT. The structure data IDT may include information (such as the length, thickness, and/or boundary surface shape of each of elements, such as a gate, a drain, and a source) of the target semiconductor device SD.

Based on first data DT1 generated by the first and second measuring devices 120 and 130, the simulator 140 may generate second data DT2 through a structure simulation and an optical simulation. The first data DT1 may include the spectrum signal data SDT and the structure data IDT.

For example, the simulator 140 may use a rigorous coupled-wave analysis (RCWA) algorithm. The RCWA algorithm may be useful for describing diffraction and/or reflection of an electromagnetic wave from a surface having a lattice structure. However, the example embodiments are not limited thereto. For example, the simulator 140 may use spectral imaging ellipsometry, multi-point high-speed measurement spectroscopic ellipsometry, and/or the like to monitor a profile change trend in the target semiconductor device SD. The simulator 140 may perform a parameter separation algorithm, such as a correlation analysis algorithm, a main component analysis algorithm, and/or a rank test, for extracting a profile change value from a plurality of spectra.

The prediction module 110 may train the neural network models 112 and 114 based on the spectrum signal data SDT generated by the first measuring device 120, the structure data IDT measured by the second measuring device 130, and the second data DT2 augmented by the simulator 140 through simulations such that the neural network models 112 and 114 predict a device structure.

FIG. 1B illustrates a device structure simulation system 160 according to some example embodiments.

The device structure simulation system 160 may analyze input data in real time based on a neural network, extract valid information, and predict a device structure and/or monitor processes based on the valid information.

For example, the device structure simulation system 160 may be applied to a measurement monitoring system (and/or the like) and/or be mounted on any other various kinds of electronic devices.

The device structure simulation system 160 may include at least one intellectual property (IP) block and a neural network processor 162. For example, the device structure simulation system 160 may include first to third IP blocks IP1, IP2, and IP3 and the neural network processor 162.

The device structure simulation system 160 may include various kinds of IP blocks. For example, the IP blocks may include a processing unit, a plurality of cores include in a processing unit, a multi-format codec (MFC), a video module (e.g., a camera interface, a JPEG processor, a video processor, or a mixer), a 3D graphics core, an audio system, a display driver, volatile memory, non-volatile memory, a memory controller, an input/output interface block, cache memory, and/or the like. Each of the first to third IP blocks IP1, IP2, and IP3 may include at least one of the various kinds of IP blocks.

A technique of connecting IPs includes a connection method based on a system bus. For example, the advanced microcontroller bus architecture (AMBA) protocol of Advanced RISC Machine (ARM) may be used as a standard bus protocol. Bus types of the AMBA protocol may include an advanced high-performance bus (AHB), an advanced peripheral bus (APB), an advanced extensible interface (AXI), AXI4, AXI coherency extensions (ACE), and/or the like. Among these bus types, AXI as an interface protocol among IPs may provide a multiple outstanding address function, a data interleaving function, and/or the like. Besides the above, other types of protocols such as uNetwork of SONICs Inc., CoreConnect of IBM, and Open Core Protocol of OCP-IP may be used.

The neural network processor 162 may generate a neural network, train a neural network, perform an operation of a neural network, based on received input data, and generate an information signal based on an operation result, and/or retrain a neural network. For example the neural network models may include various kinds of models, e.g., a CNN such as GoogleNet, AlexNet, or VGG Network, an R-CNN, an RPN, an RNN, an S-DNN, an S-SDNN, a deconvolution network, a DBN, an RBM, a fully convolutional network, an LSTM network, and/or a classification network, but the example embodiments are not limited thereto. The neural network processor 162 may use various algorithms, such as a meta-learning algorithm and an ensemble algorithm including voting, bagging, boosting, and/or stacking, to train neural network models, but the example embodiments are not limited thereto.

The neural network processor 162 may include at least one processor configured to perform operations of neural network models. The neural network processor 162 may include a separate memory that stores programs corresponding to neural network models. The neural network processor 162 may be referred to as a neural network processing device, a neural network integrated circuit, and/or a neural network processing unit (NPU).

The neural network processor 162 may receive various kinds of input data from at least one IP block through a system bus and generate an information signal based on the input data. For example, the neural network processor 162 may generate an information signal by performing a neural network operation on input data. For example, the neural network operation may include a convolution operation. The information signal generated by the neural network processor 162 may include at least one of various kinds of recognition signals, such as a voice recognition signal, an object recognition signal, an image recognition signal, a biometric information recognition signal, and/or the like. For example, the neural network processor 162 may receive, as input data, frame data included in a video stream and generate, from the frame data, a recognition signal for an object included in an image represented by the frame data. However, the example embodiments are not limited thereto. The neural network processor 162 may receive various kinds of input data and generate a recognition signal according to the input data.

According to some example embodiments, the neural network processor 162 of the device structure simulation system 160 may enhance device structure prediction performance (e.g., through a stacking model and/or a meta-learning model) and, therefore, the accuracy of the neural network processor 162 may also be increased.

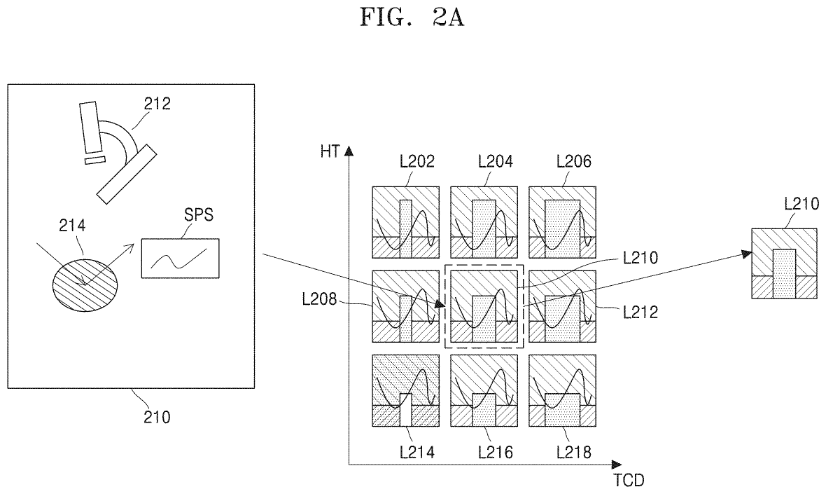

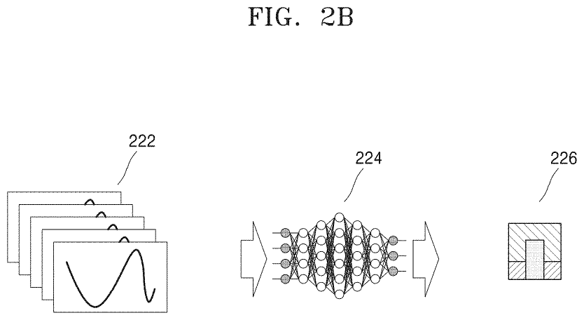

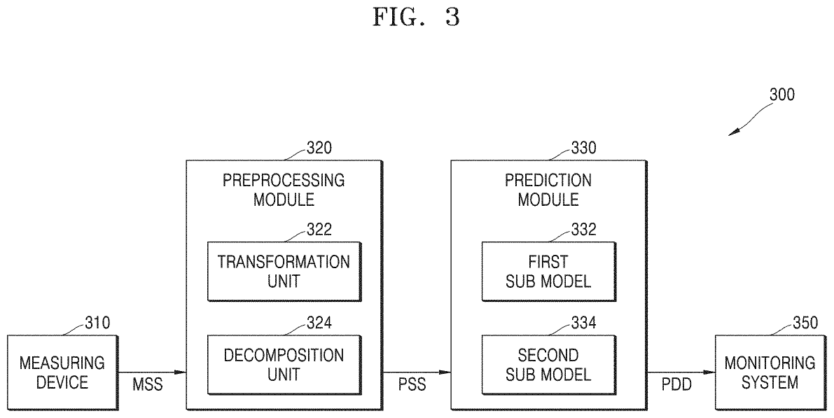

FIGS. 2A and 2B are diagrams for describing a method of measuring a device structure, according to a comparative example.

To non-destructively test (NDT) a structure (e.g., measure the structure without destroying a sample) three-dimensional (3D) profile measurement technology based on an optical method may be used. The 3D profile measurement technology may include optical critical dimension (OCD) metrology, which is a technique of extracting a profile through electromagnetic interpretation of light scattered from a micro-pattern. For example, an ellipsometer may emit a wavelength of polarized visible light to a sample, measure a reflected spectrum signal, and measure a structure by analyzing the reflected spectrum signal.

Referring to FIG. 2A, to generate a measurement model that uses a library-based measurement method 210, an experiment sample needs to be prepared to measure a target item. To use the library-based measurement method 210, a reference sample reflecting variously transformed structures of the target item may be prepared. Structure data may be generated by measuring a spectrum signal SPS of the reference sample using an OCD equipment 214 and measuring the reference sample with an SEM 212, and a measurement model may be generated. The library-based measurement method 210 may generate a final library after the consistency of the measurement model is sufficiently and/or completely verified. The library-based measurement method 210 may measure a device using a best match of the spectrum signal SPS.

For example, the final library generated by the library-based measurement method 210 may include L202, L204, L206, L208, L210, L212, L214, L216, and L218. The library-based measurement method 210 may select L210 having the highest matching rate with respect to the spectrum signal SPS from the final library after the spectrum signal SPS is measured.

Referring to FIG. 2B, in the case of a learning-based measurement method, training data of a target item may be collected, and a neural network 224, in which input data 222 is a spectrum signal and output data 226 is a measurement value, may be trained. Because training data is usually not sufficient, modeling may be performed after augmenting data through a structure simulation, an optical simulation, and so on. The learning-based measurement method may generate a final measurement model after the consistency of a trained neural network is verified.

In the case of the library-based measurement method 210, a sample to be used as a reference needs to be personally prepared, and it may take much time and cost to obtain a spectrum signal and an SEM measurement value of the sample. Accordingly, when a new process is introduced, a new sample needs to be prepared and undergo modeling. As a result, the adaptive capacity of the modeling decreases.

The learning-based measurement method saves cost for sample preparation but depends on minor training data because of the difficulty in collecting training data. Accordingly, the learning-based measurement method may cause overfitting and may be vulnerable to unseen data that is not included in the training data. Moreover, when out-of-distribution data is given as input in the learning-based measurement method, it may be difficult to apply the out-of-distribution (OOD) data to the measurement model.

According to example embodiments, to compensate for the vulnerability of existing measurement methods, a robust model may be created by introducing spectrum specific preprocessing using transformation and/or decomposition, and simulation data used for data augmentation and previous product data may be effectively used by applying stacking and/or meta-learning to a model.

FIG. 3 is a diagram of a device structure simulation system 300 according to some example embodiments.

The device structure simulation system 300 may include a measuring device 310, a preprocessing module 320, a prediction module 330, and a monitoring system 350.

The measuring device 310 may measure a device structure. For example, the measuring device 310 may include an ellipsometer. The measuring device 310 may measure a target semiconductor device and generate spectrum signal data MSS.

The preprocessing module 320 may perform preprocessing, such as noise removal and/or signal compression, on the spectrum signal data MSS generated by the measuring device 310 and generate preprocessed spectrum signal data PSS. The preprocessing module 320 may include a transformation unit 322 and a decomposition unit 324.

The transformation unit 322 may perform a wavelet transform, by which the spectrum signal data MSS is separated into sets of basis functions, to remove an optical measurement noise component from the long-wavelength band of the spectrum signal data MSS. For example, the transformation unit 322 may include a package or function such as a discrete wavelet transform, a fast Fourier transform, a discrete cosine transform, and/or the like.

The decomposition unit 324 may decompose the spectrum signal data MSS to relate a spectrum wavelength band that is used to and/or is important to infer a target. Decomposition may include cross decomposition that extracts a linear combination variable giving the maximum covariance between an X variable and a Y variable. The decomposition unit 324 may select important data from the spectrum signal data MSS and reduce the dimension of data.

The prediction module 330 may generate device structure prediction data PDD based on the preprocessed spectrum signal data PSS. The prediction module 330 may analyze input data based on a neural network, extract valid information from the input data, and predict a device structure based on the valid information or control the elements of a simulation apparatus, on which the prediction module 330 is mounted. The prediction module 330 may generate a neural network, train a neural network, or perform an operation of a neural network, based on received input data, and generate an information signal based on an operation result, or retrain a neural network. The prediction module 330 may include a hardware accelerator to execute a neural network. For example, the hardware accelerator may include a dedicated module (such as an NPU, a TPU, a neural engine and/or the like) for execution of a neural network but the example embodiments are not limited thereto.

The prediction module 330 may use various algorithms, e.g., an ensemble algorithm including voting, bagging, boosting, and/or stacking, to train neural network models. The prediction module 330 may perform a stacking algorithm using a combination of trained models to generate a measurement model. The prediction module 330 may include a first sub model 332 and a second sub model 334 to perform a stacking algorithm. For example, the first sub model 332 may include a regression model, which is trained based on simulation spectrum data and simulation device structure data generated by an RCWA simulation, and the second sub model 334 may include a regression model, which is trained based on spectrum data measured by the measuring device 310 and the first sub model 332.

The monitoring system 350 may receive the preprocessed spectrum signal data PSS from the prediction module 330 and use the device structure prediction data PDD to monitor a profile change trend of a target device, generally control a process, and monitor a process result.

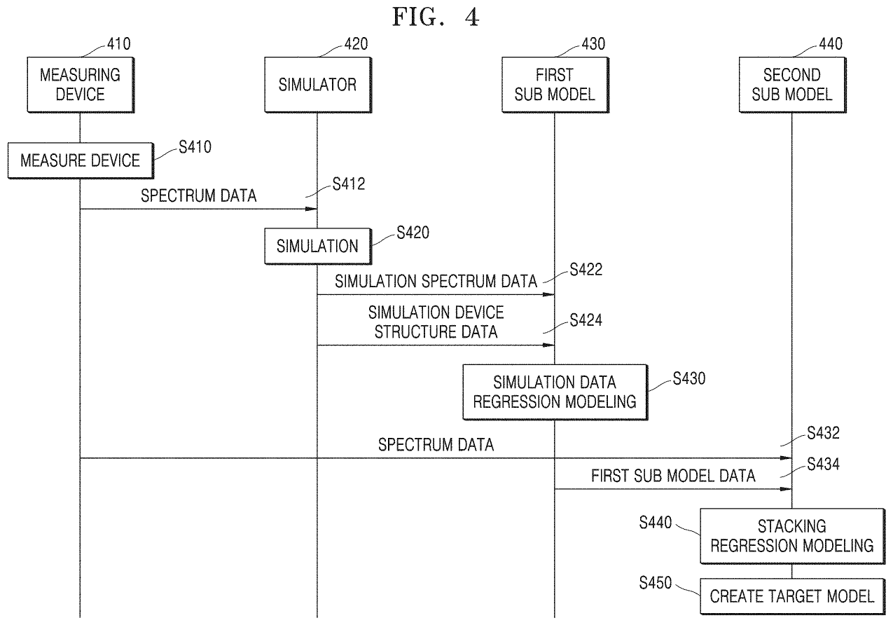

FIG. 4 is a flowchart of a method of simulating a device structure, according to some example embodiments.

A device structure simulation system using a stacking algorithm may include a measuring device 410, a simulator 420, a first sub model 430, and a second sub model 440. The measuring device 410 may be (and/or include) the first and/or second measuring devices 120 and 130 of FIG. 1 and/or the measuring device 310 of FIG. 3; the simulator 420 may be (and/or include) the simulator 140 of FIG. 1; and/or the first and second sub model 430 and 440 may be (and/or include) the neural network models 113 and 114 of FIG. 1 and/or the first and second sub models 332 and 334 of FIG. 3. For brevity, the repeated descriptions may be omitted.

The measuring device 410 may measure a target device and generate spectrum data in operation S410. The simulator 420 may receive the spectrum data generated by the measuring device 410 in operation S412 and perform a simulation based on the spectrum data in operation S420. The simulator 420 may generate simulation spectrum data and simulation device structure data through the simulation.

The first sub model 430 may receive the simulation spectrum data generated by the simulator 420 in operation S422 and receive the simulation device structure data generated by the simulator 420 in operation S424. The first sub model 430 may perform simulation data regression modeling using the simulation spectrum data and the simulation device structure data as input in operation S430.

The second sub model 440 may receive the spectrum data generated by the measuring device 410 in operation S432 and receive, in operation S434, a trained (and/or regression) model and/or data, which is generated by the first sub model 430. The second sub model 440 may perform, in operation S440, stacking regression modeling based on the received data. The second sub model 440 may create a target model by compensating for an error between actual measurement data and the first sub model 430 generated based on simulation data in operation S450.

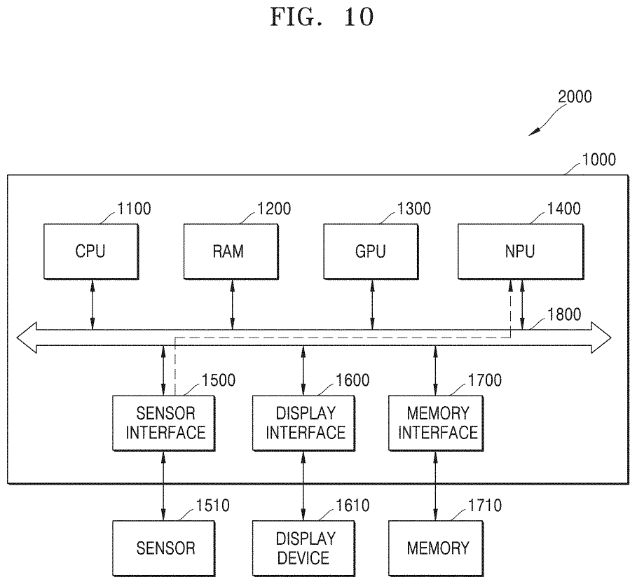

The target model may be used (e.g., by the integrated circuit 1000 of FIG. 10) to predict the structure and/or performance of a semiconductor based on a design, e.g., before the semiconductor is manufactured. The target model may be used, for example, to confirm a design indicating that the design is allowed to proceed to manufacturing and/or for forwarding the design to a processor controlling semiconductor manufacturing equipment. For example, if the design is predicted to result in a semiconductor device with sufficiently proper characteristics (e.g., is within machine tolerances), the semiconductor manufacturing equipment may then manufacture a semiconductor device based on the confirmed design.

In some example embodiments, the target model may be used to determine that the production of a semiconductor device should be paused (and/or stopped) if, e.g., the design would result in semiconductor devices with characteristics below a threshold value. For example, in some example embodiments a warning and/or a representation of how a manufactured device (and/or the characteristics thereof) would differ from the design (and/or the characteristics thereof) may be provided to a user (e.g., on the display device 1610 of FIG. 10). In some example embodiments, the target model may be used to identify the source of the difference, suggest (and/or provide) a modification correcting the flaw, and may be used to produce a semiconductor device based on the corrected design.

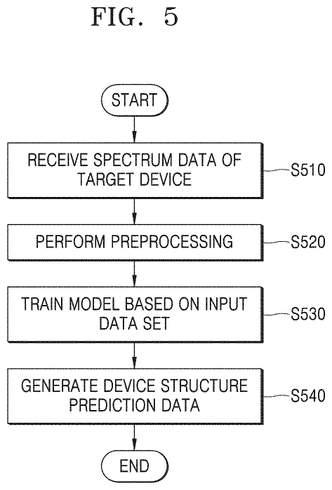

FIG. 5 is a flowchart of a method of simulating a device structure, according to some example embodiments.

A device structure simulation apparatus may receive spectrum data of a target device in operation S510. The spectrum data may be generated with respect to a semiconductor device by a measuring device including an ellipsometer.

The device structure simulation apparatus may perform preprocessing on the spectrum data in operation S520. For example, the device structure simulation apparatus may perform preprocessing (such as noise removal or signal compression) on spectrum signal data generated by a measuring device and generate preprocessed spectrum signal data.

The preprocessing may include a transform algorithm such as a discrete wavelet transform, a fast Fourier transform, a discrete cosine transform, and/or the like. The preprocessing may include a spectrum signal decomposition algorithm such as cross decomposition. A linear combination variable giving the maximum covariance between the spectrum data and the structure of the target device may be generated through the cross decomposition. Through the preprocessing, the dimension of the spectrum data may be reduced, and data highly related to prediction of the structure of the target device may be selected.

The device structure simulation apparatus may train a model based on an input data set in operation S530. The input data set may include simulation data and measurement data of the target device.

The device structure simulation apparatus may generate device structure prediction data based on the trained model in operation S540. The structure of the target device may include, e.g., at least one selected from the thickness, height, length, and/or boundary surface curvature of a sub element of the target device. The sub element may include, e.g., at least one selected from the source, gate, drain, and/or channel of a transistor.

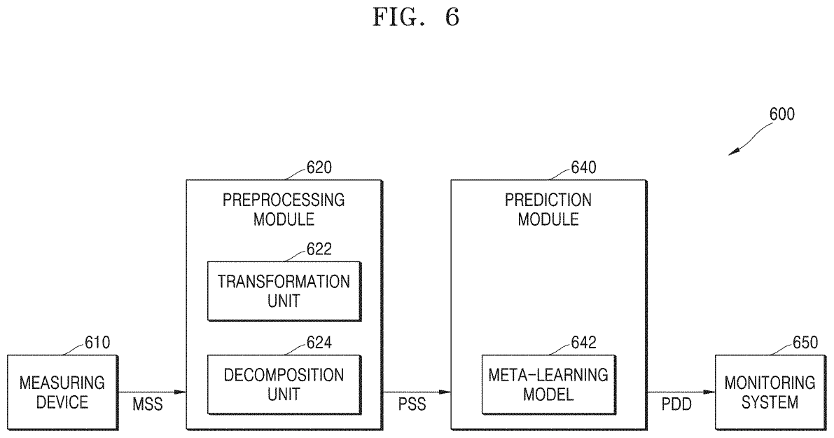

FIG. 6 is a diagram of a device structure simulation system 600 according to some example embodiment.

The device structure simulation system 600 may include a measuring device 610, a preprocessing module 620, a prediction module 640, and a monitoring system 650.

The measuring device 610 may measure a device structure. For example, the measuring device 610 may include an ellipsometer. The measuring device 610 may measure a target semiconductor device and generate spectrum signal data MSS.

The preprocessing module 620 may perform preprocessing, such as noise removal and/or signal compression, on the spectrum signal data MSS generated by the measuring device 610 and generate preprocessed spectrum signal data PSS. The preprocessing module 620 may include a transformation unit 622 and a decomposition unit 624.

The transformation unit 622 may perform a wavelet transform, by which the spectrum signal data MSS is separated into sets of basis functions, to remove an optical measurement noise component from the long-wavelength band of the spectrum signal data MSS. For example, the transformation unit 622 may include a package or function such as a discrete wavelet transform, a fast Fourier transform, a discrete cosine transform, and/or the like.

The decomposition unit 624 may decompose the spectrum signal data MSS to relate a spectrum wavelength band that is used to and/or is important to infer a target. Decomposition may include cross decomposition that extracts a linear combination variable giving the maximum covariance between an X variable and a Y variable. The decomposition unit 624 may select important data from the spectrum signal data MSS and reduce the dimension of data.

The prediction module 640 may generate device structure prediction data PDD based on the preprocessed spectrum signal data PSS. The prediction module 640 may analyze input data based on a neural network, extract valid information from the input data, and predict a device structure based on the valid information or control the elements of a simulation apparatus, on which the prediction module 640 is mounted. The prediction module 640 may generate a neural network, train a neural network, or perform an operation of a neural network, based on received input data, and generate an information signal based on an operation result, or retrain a neural network. The prediction module 640 may include a hardware accelerator to execute a neural network. For example, the hardware accelerator may include a dedicated module, such as an NPU, a TPU, a neural engine, and/or the like, for execution of a neural network, but the example embodiments are not limited thereto.

The prediction module 640 may include a meta-learning model 642 and use a meta-learning algorithm to train neural network models. The meta-learning algorithm may learn “to learn data” when a measurement model is generated. For example, the prediction module 640 may perform meta-learning using previous device data (and/or the like) and set an initial value of weight data of the meta-learning model 642. The prediction module 640 may search for optimal initial weight data through a meta-learning process. The prediction module 640 may retrain the meta-learning model 642 based on the optimal initial weight data and/or target device data. For example, as described below, the prediction module 640 may use the optimal weight data and/or the target device data during the retraining to prevent and/or lower the potential that the meta-learning process converges to a false result (such as an overfit result).

The monitoring system 650 may receive the device structure prediction data PDD generated by the prediction module 640 and use the device structure prediction data PDD to monitor a profile change trend of a target device, generally control a process, and monitor a process result.

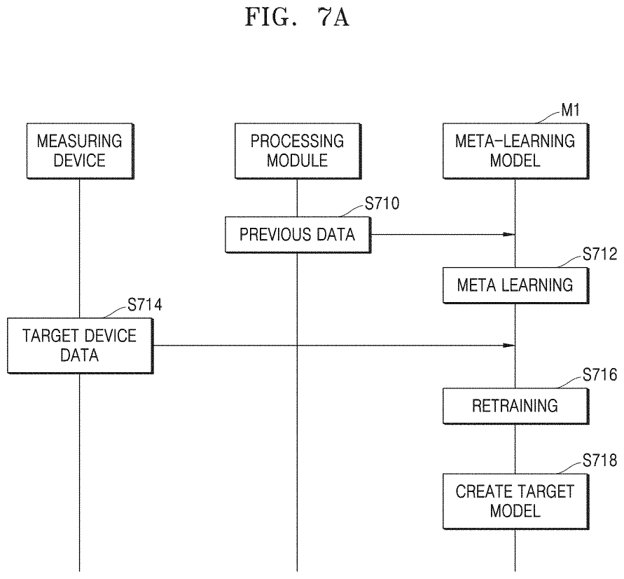

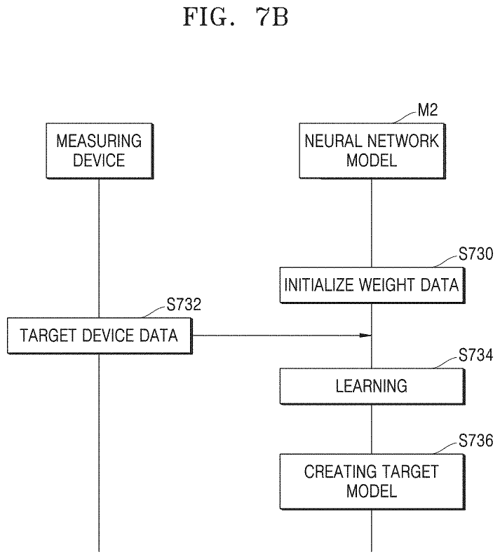

FIG. 7A is a flowchart of a method of simulating a device structure, according to some example embodiments. FIG. 7B is a flowchart of a comparative example.

A neural network usually requires a large amount of training data and sufficient learning time, and many tasks suffer overfitting because of a small amount of training data. Meta-learning as a machine learning algorithm for learning how to learn may overcome overfitting caused by deficient training data.

Referring to FIG. 7A, a meta-learning model M1 according to some embodiments may overcome overfitting caused by deficient training data by using previous data. The meta-learning model M1 may receive previous data in operation S710. The previous data may include device data from previous generation, device data of other lines in the same generation, or the like.

The meta-learning model M1 may perform meta-learning based on the previous data in operation S712. During the meta-learning, the meta-learning model M1 may generate optimal weight data.

After the meta-learning based on the previous data, the meta-learning model M1 may receive target device data in operation S714. The target device data may include spectrum data measured from a device to be monitored.

The meta-learning model M1 may be retrained based on the target device data in operation S716. Because the meta-learning model M1 is retrained using weight data searched for during the meta-learning, the meta-learning model M1 may reliably operate even in the case of deficient training data.

The meta-learning model M1 may finally create a target model, which predicts a device structure, through the meta-learning and the retraining in operation S718.

Referring to FIG. 7B, a neural network model M2 in general may initialize a weight value to 0 or a random value and may be trained based on target data.

The neural network model M2 may initialize weight data to 0 in operation S730. Besides the method of initializing data to 0, the neural network model M2 may randomly initialize a weight using an activation function, e.g., a sigmoid function. Weight initialization is not limited to those above, and various initialization algorithms may be used.

The neural network model M2 may receive target device data in operation S732. The target device data may include spectrum data measured from a device to be monitored.

The neural network model M2 may be trained based on the target device data in operation S734 and finally create a target model predicting a device structure in operation S736. The neural network model M2 may cause overfitting when there is deficient training data and have degradation in prediction performance when there is no training data corresponding to an input.

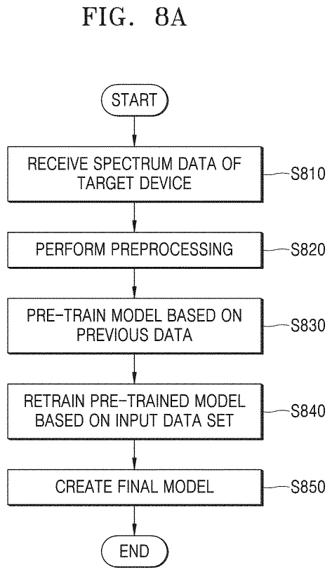

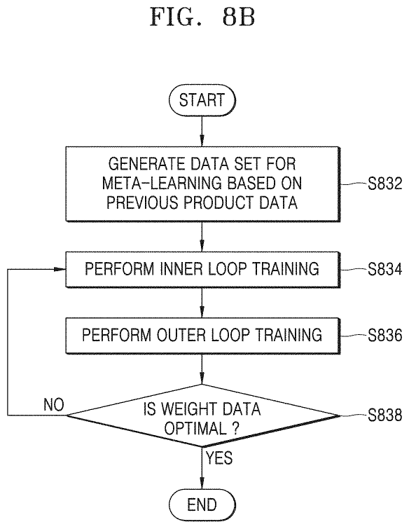

FIG. 8A is a flowchart of a method of simulating a device structure, according to some example embodiments. FIG. 8B is a flowchart of a meta-learning algorithm according to some example embodiments.

A device structure simulation apparatus may receive spectrum data of a target device in operation S810. The spectrum data may be generated with respect to a semiconductor device by a measuring device including an ellipsometer.

The device structure simulation apparatus may perform preprocessing on the spectrum data in operation S820. The device structure simulation apparatus may perform preprocessing (such as noise removal and/or signal compression) on spectrum signal data generated by a measuring device and generate preprocessed spectrum signal data.

The preprocessing may include a transform algorithm such as a discrete wavelet transform, a fast Fourier transform, a discrete cosine transform, and/or the like. The preprocessing may include a spectrum signal decomposition algorithm such as cross decomposition. A linear combination variable giving the maximum covariance between the spectrum data and the structure of the target device may be generated through the cross decomposition. Through the preprocessing, the dimension of the spectrum data may be reduced, and data highly related to prediction of the structure of the target device may be selected.

The device structure simulation apparatus may pre-train a model based on previous data in operation S830. The pre-training may be for learning how to learn in a meta-learning algorithm. The pre-training is described below with reference to FIG. 8B.

The device structure simulation apparatus may retrain the pre-trained model based on an input data set in operation S840. For example, the device structure simulation apparatus may retrain the pre-trained model based on the input data set using optimal weight data of the pre-trained model. The input data set may include simulation data and measurement data of the target device.

The device structure simulation apparatus may create a final model, which predicts a device structure, through the pre-training and the retraining in operation S850.

FIG. 8B is a diagram to describe in detail operation S830 in FIG. 8A.

The device structure simulation apparatus may generate a data set for meta-learning based on previous product data in operation S832.

The device structure simulation apparatus may perform inner loop learning in operation S834. During the inner loop learning, task sampling may be performed on the data set for meta-learning. After the task sampling, the model may be trained based on training data of each data set for the meta-learning.

The device structure simulation apparatus may perform outer loop learning in operation S836.

During the outer loop learning, a gradient value may be calculated from test data of the data set for meta-learning. The test data may include a task sampled during the inner loop learning. The device structure simulation apparatus may update weight data, based on the gradient value.

The device structure simulation apparatus may determine whether the weight data is optimal in operation S838 and terminates the method when the weight data is optimal. When the device structure simulation apparatus determines that the weight data is not optimal, the device structure simulation apparatus may repeat the inner loop learning in operation S834 and the outer loop learning in operation S836.

The device structure simulation apparatus may use optimal weight data as an initial value of the weight data in operation S840 in FIG. 8A.

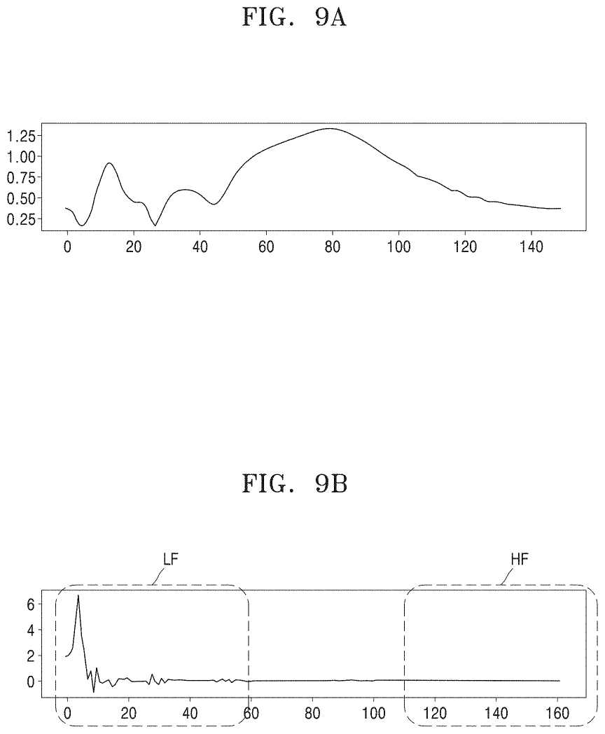

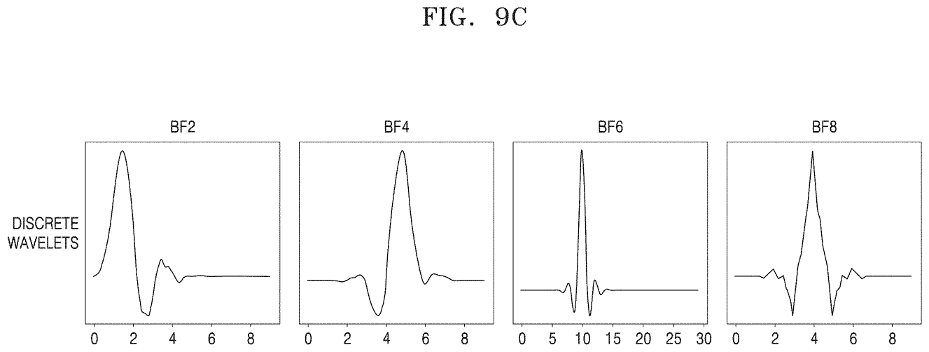

FIGS. 9A to 9C are diagrams for describing preprocessing according to some example embodiments.

FIG. 9A illustrates spectrum signal data of a target device before the preprocessing. FIG. 9B illustrates data resulting from performing a discrete wavelet transform on the spectrum signal data.

When the spectrum signal data is separated into sets of basis functions, noise may be removed from the spectrum signal data and the spectrum signal data may be effectively compressed. Referring to FIG. 9B, transformed spectrum signal data may be classified into a short-wavelength band LF and a long-wavelength band HF. There may be an optical measurement noise component in the long-wavelength band HF of the transformed spectrum signal data.

FIG. 9C illustrates various basis functions used for the discrete wavelet transform. For example, a first basis function BF2 may be a Daubechies wavelet basis function, a second basis function BF4 may be a Symlets wavelet basis function, a third basis function BF6 may be a Coiflets wavelet basis function, and a fourth basis function BF8 may be a biorthogonal wavelet basis function. Besides the first to fourth basis functions BF2, BF4, BF6, and BF8, other various types of basis functions may be used for the discrete wavelet transform. Basis functions may be different in performance according to the characteristics of data to undergo the discrete wavelet transform. An appropriate basis function may be selected according to the characteristics of data and the purpose of the discrete wavelet transform and used to perform the preprocessing including the discrete wavelet transform.

FIG. 10 is a block diagram illustrating an apparatus 2000 including an integrated circuit 1000 according to some example embodiments.

The apparatus 2000 may include the integrated circuit 1000 and elements, e.g., a sensor 1510, a display device 1610, and a memory 1710, which are connected to the integrated circuit 1000. The apparatus 2000 may process data based on a neural network. For example, the apparatus 2000 may include (and/or be included in) a mobile device such as a process simulator, a smartphone, a game console, and/or a wearable device.

According to some example embodiments, the integrated circuit 1000 may include a central processing unit (CPU) 1100, random access memory (RAM) 1200, a GPU 1300, an NPU 1400, a sensor interface 1500, a display interface 1600, and a memory interface 1700. Besides those above, the integrated circuit 1000 may further include general-purpose elements such as a communication module, a DSP, and a video module, but the example embodiments are limited thereto. The elements (e.g., the CPU 1100, the RAM 1200, the GPU 1300, the NPU 1400, the sensor interface 1500, the display interface 1600, and the memory interface 1700) of the integrated circuit 1000 may exchange data with each other through a bus 1800. In some example embodiments, the integrated circuit 1000 may correspond to an application processor. In some example embodiments, the integrated circuit 1000 may be implemented as a system-on-chip (SoC).

The CPU 1100 may generally control operations of the integrated circuit 1000. The CPU 1100 may include a single core and/or multiple cores. The CPU 1100 may process and/or execute programs and/or data, which are stored in the memory 1710. In some example embodiments, the CPU 1100 may control the functions of the NPU 1400 by executing the programs stored in the memory 1710.

The RAM 1200 may temporarily store programs, data, and/or instructions. In some example embodiments, the RAM 1200 may include dynamic RAM (DRAM) and/or static RAM (SRAM). The RAM 1200 may temporarily store data, e.g., image data, which is input and/or output through interfaces (e.g., the sensor interface 1500 and/or the display interface 1600) and/or which is generated by the GPU 1300 and/or the CPU 1100.

In some example embodiments, the integrated circuit 1000 may further include read-only memory (ROM). The ROM may store programs and/or data, which are continuously used. The ROM may include, for example, erasable programmable ROM (EPROM) and/or electrically erasable programmable ROM (EEPROM).

The GPU 1300 may perform image processing on image data. For example, the GPU 1300 may perform image processing on image data that is received through the sensor interface 1500. The image data processed by the GPU 1300 may be stored in the memory 1710 and/or provided to the display device 1610 through the display interface 1600. The image data stored in the memory 1710 may also be provided to the NPU 1400.

The sensor interface 1500 may interface with data (e.g., image data, audio data, etc.) input from the sensor 1510 connected to the integrated circuit 1000.

The display interface 1600 may interface with data (e.g., an image) output to the display device 1610. The display device 1610 may output an image or data about the image through a display such as a liquid crystal display (LCD), a light-emitting diode (LED) display), a quantum dot (QD) display, an active matrix organic light-emitting diode (AMOLED) display, and/or the like.

The memory interface 1700 may interface with data input from the memory 1710 outside the integrated circuit 1000 and/or data output to the memory 1710. According to some example embodiments, the memory 1710 may include volatile memory (such as DRAM and/or SRAM) and/or non-volatile memory (such as resistive RAM (ReRAM), phase-change RAM (PRAM), and/or NAND flash memory). In some example embodiments, the memory 1710 may include detachable memory such a detachable hard drive and/or a memory card (e.g., a multimedia card (MMC), an embedded MMC (eMMC), a secure digital (SD) card, a micro-SD card) and/or the like.

The prediction module 110 in FIG. 1A may be used as the NPU 1400. The NPU 1400 may receive, with respect to a device structure, simulation data and measurement spectrum data from an external measuring device and may be trained based on the simulation data and the measurement spectrum data so as to predict the device structure.

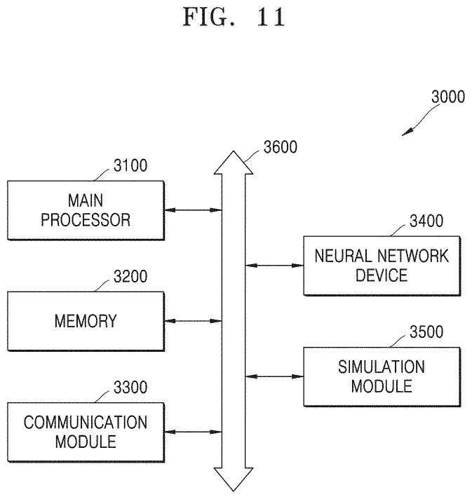

FIG. 11 is a block diagram of a device structure simulation system 3000 including a neural network device 3400, according to some example embodiments.

Referring to FIG. 11, the device structure simulation system 3000 may include a main processor 3100, a memory 3200, a communication module 3300, the neural network device 3400, and a simulation module 3500. The elements of the device structure simulation system 3000 may communicate with each other through a bus 3600.

The main processor 3100 may generally control operations of the device structure simulation system 3000. For example, the main processor 3100 may include, e.g., a CPU. The main processor 3100 may include a single core and/or multiple cores. The main processor 3100 may process and/or execute programs and/or data, which are stored in the memory 3200. For example, the main processor 3100 may control the neural network device 3400 to drive a neural network and create a process simulation model through inductive transfer learning by executing the programs stored in the memory 3200.

The communication module 3300 may include various wired or wireless interfaces, which may communicate with external devices. The communication module 3300 may receive a trained target neural network from a server and a sensor network generated through reinforcement learning. The communication module 3300 may include a communication interface that may be connected to a mobile cellular network, such as a local area network (LAN), a wireless LAN (WLAN) like Wireless Fidelity (Wi-fi), a wireless personal area network (WPAN) like Bluetooth, a wireless universal serial bus (USB), Zigbee, near field communication (NFC), radio-frequency identification (RFID), power line communication (PLC), third-generation (3G), fourth-generation (4G), fifth-generation (5G), and/or long-term evolution (LTE).

The simulation module 3500 may process various kinds of input/output data to simulate semiconductor processes. For example, the simulation module 3500 may include equipment that measures manufactured semiconductors and provide actual measurement data to the neural network device 3400. The simulation module 3500 may include, for example, the simulator 140 of FIG. 1 and/or the simulator 420 of FIG. 4.

The neural network device 3400 may perform neural network operations based on device data, e.g., spectrum data, generated by the simulation module 3500 and/or device structure information measured through an electron microscope. The prediction module 110 described with reference to FIGS. 1 to 10 may be used as the neural network device 3400. The device structure simulation system 3000 may remove noise by performing preprocessing on the spectrum data and provide compressed data to the neural network device 3400. The neural network device 3400 may be trained based on a stacking model or a meta-learning model, and accordingly, the data processing accuracy of the device structure simulation system 3000 may be increased.

The device described herein may comprise a processor, a memory for storing program data and executing it, a permanent storage unit such as a disk drive, a communication port for handling communications with external devices, and user interface devices, including a touch panel, keys, buttons, etc. When software modules and/or algorithms are involved, these software modules (and/or algorithms) may be stored as program instructions or computer-readable code executable on a processor on a computer-readable recording medium. Examples of the computer-readable recording medium include magnetic storage media (e.g., ROM, RAM, floppy disks, hard disks, etc.) and optical recording media (e.g., CD-ROMs, digital versatile disks (DVDs), etc.). The computer-readable recording medium can also be distributed over network-coupled computer systems so that the computer-readable code is stored and executed in a distributive manner. This media can be read by the computer, stored in the memory, and executed by the processor.

The example embodiments may be described in terms of functional block components and various processing steps. Such functional blocks may be realized by any number of hardware and/or software components configured to perform the specified functions. For example, embodiments may employ various integrated circuit components, e.g., memory elements, processing elements, logic elements, look-up tables, and/or the like, which may carry out a variety of functions under the control of one or more microprocessors and/or other control devices. Similarly, where the elements of embodiments are implemented using software programming or software elements, embodiments may be implemented with any programming or scripting language such as C, C++, Java, assembler language, and/or the like, with the various algorithms being implemented with any combination of data structures, object, processes, routines, and/or other programming elements. Functional aspects may be implemented in algorithms that are executed on one or more processors. Furthermore, embodiments could employ any number of conventional techniques for electronics configuration, signal processing and/or control, data processing and the like.

While the inventive concepts have been particularly shown and described with reference to embodiments thereof, it will be understood that various changes in form and details may be made therein without departing from the spirit and scope of the following claims.

1. A device structure simulation apparatus comprising:
a memory storing a device structure simulation program; and
a processor configured to execute the device structure simulation program stored in the memory, such that, by executing the device structure simulation program, the device structure simulation apparatus is configured to
receive spectrum data of a target device,
generate an input data set by performing preprocessing on the spectrum data, and
train a model based on the input data set such that the model is configured to predict a structure of the target device,
wherein the preprocessing includes selecting a certain basis function based on the spectrum data, and separating the spectrum data into sets of certain basis functions, and
the model includes at least one sub model.

2. The device structure simulation apparatus of claim 1, wherein
the input data set includes simulation data and measurement data, and
the at least one sub model includes a first sub model and a second sub model, the first sub model trained based on the simulation data, and the second sub model trained based on the measurement data.

3. The device structure simulation apparatus of claim 2, wherein the device structure simulation apparatus is further configured to
generate device structure data through a simulation, based on the measurement data, and
generate device spectrum data based on the device structure data,
wherein the simulation data includes the device structure data and the device spectrum data.

4. The device structure simulation apparatus of claim 2, wherein the device structure simulation apparatus is further configured to
train the first sub model based on the simulation data. and
train the second sub model based on the first sub model and the measurement data.

5. The device structure simulation apparatus of claim 1, wherein
the at least one sub model includes a first sub model and a second sub model, the first sub model trained based on previous data, and the second sub model being trained based on the input data set,
the first sub model includes initial weight data, and
the second sub model includes retrained weight data resulting from retraining the initial weight data, based on the input data set.

6. The device structure simulation apparatus of claim 5, wherein
the model further includes a loss function that optimizes the initial weight data, and
the loss function generates first gradient data and second gradient data, the first gradient data based on the previous data, the second gradient data based on the input data set, and
the loss function updates the initial weight data based on the first gradient data and the second gradient data.

7. The device structure simulation apparatus of claim 5, wherein the device structure simulation apparatus is further configured to
plot characteristics of a plurality of pieces of spectrum data in one space, the plurality of pieces of spectrum data included in the input data set, and
calculate a similarity according to a distance between the plurality of pieces of spectrum data.

8. The device structure simulation apparatus of claim 1, wherein the device structure simulation apparatus is further configured to
separate the spectrum data into a high-frequency region and a low-frequency region, and
process noise of the high-frequency region.

9. The device structure simulation apparatus of claim 1, wherein the device structure simulation apparatus is further configured to
reduce a dimension of the spectrum data. and
select data that is related to predictions of the structure of the target device.

10. The device structure simulation apparatus of claim 9, wherein the device structure simulation apparatus is further configured to
generate a linear combination variable giving a maximum covariance between the spectrum data and the structure of the target device.

11. The device structure simulation apparatus of claim 1, wherein
the prediction of the structure of the target device includes at least one selected from a thickness, height, length, or boundary surface curvature of a sub element of the target device, and
the sub element includes at least one selected from a source, gate, drain, and channel of a transistor.

12. A method of creating a model predicting a structure of a target device, the method comprising:
receiving spectrum data of the target device;
generating an input data set by performing preprocessing on the spectrum data; and
training the model based on the input data set such that the model is configured to predict the structure of the target device,
wherein the input data set includes simulation data and measurement data, and
the model includes at least a first sub model and a second sub model, the first sub model trained based on the simulation data, and the second sub model trained based on the measurement data.

13. The method of claim 12, wherein the generating of the input data set includes
generating device structure data through a simulation, based on the measurement data, and
generating device spectrum data based on the device structure data.

14. The method of claim 12, wherein the training of the model includes
training the first sub model based on the simulation data, and
training the second sub model based on the first sub model and the measurement data.

15. The method of claim 12, wherein the generating of the input data set includes
separating the spectrum data into a high-frequency region and a low-frequency region, and
processing noise of the high-frequency region.

16. The method of claim 15, wherein the generating of the input data set further includes
selecting a certain basis function based on the spectrum data, and
separating the spectrum data into sets of certain basis functions.

17.-19. (canceled)

20. A method of creating a model predicting a structure of a target device, the method comprising:
receiving spectrum data of the target device;
generating an input data set by performing preprocessing on the spectrum data;
pre-training the model based on previous data; and
retraining the pre-trained model based on the input data set such that the retrained model is configured to predict the structure of the target device.

21. The method of claim 20, wherein the pre-training of the model includes generating initial weight data of the model based on the previous data.

22. The method of claim 21, wherein
the model includes a loss function that optimizes the initial weight data, and
the pre-training of the model further includes, based on the loss function,
generating first gradient data based on the previous data,
generating second gradient data, based on the input data set, and
updating the initial weight data, based on the first gradient data and the second gradient data.

23. The method of claim 20, wherein the pre-training of the model includes
plotting characteristics of a plurality of pieces of spectrum data in one space, the plurality of pieces of spectrum data included in the input data set, and
calculating a similarity according to a distance between the plurality of pieces of spectrum data.

24.-28. (canceled)
